(19) United States
(12) Patent Application Publication
(10) Pub. No.: US 2026/0213259 A1
(43) Pub. Date: Jul. 23, 2026

(54) ELECTROLYTES, ELECTROLYTE MATERIALS, AND MANUFACTURING THEREOF

(71) Applicant: UNIGRID, INC., San Diego, CA (US)

(72) Inventors: Darren Huan Shen TAN, San Diego, CA (US); Erik Austin WU, San Diego, CA (US)

(21) Appl. No.: 19/144,042

(22) PCT Filed: Dec. 28, 2023
(86) PCT No.: PCT/US2023/086307

§ 371 Date: Jun. 27, 2025

Related U.S. Application Data
(60) Provisional application No. 63/435,782, filed on Dec. 28, 2022.

(51) Int. Cl. H01M 10/0562; H01M 4/02; H01M 4/40; H01M 4/62; H01M 10/054

(52) U.S. Cl. CPC H01M 10/0562; H01M 4/40; H01M 4/625; H01M 10/054; H01M 2004/027; H01M 2300/0068

(57) ABSTRACT

Provided herein are high performance compounds and compositions for use as electrolyte materials. Electrolyte composites materials and batteries incorporating the compounds and compositions are also disclosed. Methods of manufacturing the compounds, compositions, electrolytes and batteries are also disclosed.

### FIELD OF THE INVENTION

The field relates to electrolytes and electrolyte material, cells and batteries comprising the same, and the manufacturing thereof.

### BACKGROUND OF THE INVENTION

Batteries comprise one or more electrochemical cell, such cells generally comprising a cathode, an anode and an electrolyte. Sodium ion secondary batteries use a sodium transition metal oxide or ferrocyanide positive electrode active material and a hard carbon-based negative electrode active material and uses an electrolyte to ensure sodium ionic conductivity between the positive electrode and the negative electrode.

### SUMMARY OF THE INVENTION

According to one aspect of the present disclosure, provided in certain embodiments herein are compounds having a chemical formula of Na₂₋ₓ(C₂B₉H₁₂)ₓ(B₁₂H₁₂)₁₋ₓ, where 0<x<1.

In some compound embodiments, x is from 0.2 to 0.4. In some compound embodiments, x is about 0.33.

In some compound embodiments, x is from 0.4 to 0.6. In some compound embodiments, x is from about 0.5.

In some compound embodiments, x is from 0.6 to 0.7. In some compound embodiments, x is about 0.67.

In some compound embodiments, x is from 0.7 to 0.9. In some compound embodiments, x is about 0.75.

In some compound embodiments, the C₂B₉H₁₂ comprises 7,8-C₂B₉H₁₂. In some compound embodiments, the C₂B₉H₁₂ is 7,8-C₂B₉H₁₂.

In some compound embodiments, the C₂B₉H₁₂ comprises 7,9-C₂B₉H₁₂. In some compound embodiments, the C₂B₉H₁₂ is 7,9-C₂B₉H₁₂.

In some compound embodiments, the C₂B₉H₁₂ comprises a mixture of 7,8-C₂B₉H₁₂ and 7,9-C₂B₉H₁₂. In some compound embodiments, the C₂B₉H₁₂ is a mixture of 7,8-C₂B₉H₁₂ and 7,9-C₂B₉H₁₂.

According to one aspect of the present disclosure, provided in certain embodiments herein are compositions comprising, consisting essentially of, or consisting of, sodium cation (Na⁺), dicarbaundecaborate anion ([C₂B₉H₁₂]⁻), and dodecahydrododecaborate anion ([B₁₂H₁₂]²⁻).

In some composition embodiments, the molar ratio between dicarbaundecaborate anion and dodecahydrododecaborate anion is from 0.01 to 0.7. In some composition embodiments, the molar ratio between dicarbaundecaborate anion and dodecahydrododecaborate anion is about 0.5.

In some composition embodiments, the molar ratio between dicarbaundecaborate anion and dodecahydrododecaborate anion is from 0.7 to 1.5. In some composition embodiments, the molar ratio between dicarbaundecaborate anion and dodecahydrododecaborate anion is about 1.0.

In some composition embodiments, the molar ratio between dicarbaundecaborate anion and dodecahydrododecaborate anion is from 1.5 to 2.5. In some composition embodiments, the molar ratio between dicarbaundecaborate anion and dodecahydrododecaborate anion is about 2.0.

In some composition embodiments, the molar ratio between dicarbaundecaborate anion and dodecahydrododecaborate anion is from 2.5 to 10. In some composition embodiments, the molar ratio between dicarbaundecaborate anion and dodecahydrododecaborate anion is about 3.0.

In some composition embodiments, the dicarbaundecaborate anion comprises 7,8-dicarbaundecaborate anion ([7,8-C₂B₉H₁₂]⁻). In some composition embodiments, the dicarbaundecaborate anion is 7,8-dicarbaundecaborate anion ([7,8-C₂B₉H₁₂]⁻).

In some composition embodiments, the dicarbaundecaborate anion comprises 7,9-dicarbaundecaborate anion ([7,9-C₂B₉H₁₂]⁻). In some composition embodiments, the dicarbaundecaborate anion is 7,9-dicarbaundecaborate anion ([7,9-C₂B₉H₁₂]⁻).

In some composition embodiments, the dicarbaundecaborate anion comprises a mixture of 7,8-dicarbaundecaborate anion ([7,8-C₂B₉H₁₂]⁻) and 7,9-dicarbaundecaborate anion ([7,9-C₂B₉H₁₂]⁻). In some composition embodiments, the dicarbaundecaborate anion is a mixture of 7,8-dicarbaundecaborate anion ([7,8-C₂B₉H₁₂]⁻) and 7,9-dicarbaundecaborate anion ([7,9-C₂B₉H₁₂]⁻).

In some composition embodiments, the composition has an ionic conductivity of at least about 0.05 mS/cm. In some composition embodiments, the composition has an ionic conductivity of at least about 0.1 mS/cm. In some composition embodiments, the composition has an ionic conductivity of at least about 0.5 mS/cm. In some composition embodiments, the composition has an ionic conductivity of at least about 1.0 mS/cm. In some composition embodiments, the composition has an ionic conductivity of at least about 1.5 mS/cm. In some composition embodiments, the composition has an ionic conductivity of at least about 2.0 mS/cm.

In some composition embodiments, the composition has an ionic conductivity of at least about 2.5 mS/cm. In some composition embodiments, the composition has an ionic conductivity of at least about 2.7 mS/cm. In some composition embodiments, the composition has an ionic conductivity of at least about 3.0 mS/cm. In some composition embodiments, the composition has an ionic conductivity of at least about 3.5 mS/cm. In some composition embodiments, the composition has an ionic conductivity of at least about 4.0 mS/cm. In some composition embodiments, the composition has an ionic conductivity of at least about 4.3 mS/cm.

In some composition embodiments, the composition has an electronic conductivity of no more than about 10⁻⁶ S/cm. In some composition embodiments, the composition has an electronic conductivity of no more than about 10⁻⁷ S/cm. In some composition embodiments, the composition has an electronic conductivity of no more than about 10⁻⁸ S/cm, and preferably no more than about 10⁻⁹ S/cm.

According to one aspect of the present disclosure, provided in certain embodiments herein are compositions formed by a chemical reaction between sodium dicarbaundecaborate (NaC₂B₉H₁₂) and sodium dodecahydrododecaborate (Na₂B₁₂H₁₂).

In some composition embodiments, the chemical reaction is a one-step reaction. In some composition embodiments, the chemical reaction is completed within 3 hours. In some composition embodiments, the chemical reaction is completed within 2 hours. In some composition embodiments, the chemical reaction is completed within 1 hours.

In some composition embodiments, the molar ratio between dicarbaundecaborate anion and dodecahydrododecaborate anion is from 0.01 to 0.7. In some composition embodiments, the molar ratio between dicarbaundecaborate anion and dodecahydrododecaborate anion is about 0.5.

In some composition embodiments, the molar ratio between dicarbaundecaborate anion and dodecahydrododecaborate anion is from 0.7 to 1.5. In some composition embodiments, the molar ratio between dicarbaundecaborate anion and dodecahydrododecaborate anion is about 1.0.

In some composition embodiments, the molar ratio between dicarbaundecaborate anion and dodecahydrododecaborate anion is from 1.5 to 2.5. In some composition embodiments, the molar ratio between dicarbaundecaborate anion and dodecahydrododecaborate anion is about 2.0.

In some composition embodiments, the molar ratio between dicarbaundecaborate anion and dodecahydrododecaborate anion is from 2.5 to 10. In some composition embodiments, the molar ratio between dicarbaundecaborate anion and dodecahydrododecaborate anion is about 3.0.

In some composition embodiments, the dicarbaundecaborate anion comprises 7,8-dicarbaundecaborate anion ([7,8-C₂B₉H₁₂]⁻). In some composition embodiments, the dicarbaundecaborate anion is 7,8-dicarbaundecaborate anion ([7,8-C₂B₉H₁₂]⁻).

In some composition embodiments, the dicarbaundecaborate anion comprises 7,9-dicarbaundecaborate anion ([7,9-C₂B₉H₁₂]⁻). In some composition embodiments, the dicarbaundecaborate anion is 7,9-dicarbaundecaborate anion ([7,9-C₂B₉H₁₂]⁻).

In some composition embodiments, the dicarbaundecaborate anion comprises a mixture of 7,8-dicarbaundecaborate anion ([7,8-C₂B₉H₁₂]⁻) and 7,9-dicarbaundecaborate anion ([7,9-C₂B₉H₁₂]⁻). In some composition embodiments, the dicarbaundecaborate anion is a mixture of 7,8-dicarbaundecaborate anion ([7,8-C₂B₉H₁₂]⁻) and 7,9-dicarbaundecaborate anion ([7,9-C₂B₉H₁₂]⁻).

In some composition embodiments, the composition has an ionic conductivity of at least about 0.05 mS/cm. In some composition embodiments, the composition has an ionic conductivity of at least about 0.1 mS/cm. In some composition embodiments, the composition has an ionic conductivity of at least about 0.5 mS/cm. In some composition embodiments, the composition has an ionic conductivity of at least about 1.0 mS/cm. In some composition embodiments, the composition has an ionic conductivity of at least about 1.5 mS/cm. In some composition embodiments, the composition has an ionic conductivity of at least about 2.0 mS/cm.

In some composition embodiments, the composition has an ionic conductivity of at least about 2.5 mS/cm. In some composition embodiments, the composition has an ionic conductivity of at least about 2.7 mS/cm. In some composition embodiments, the composition has an ionic conductivity of at least about 3.0 mS/cm. In some composition embodiments, the composition has an ionic conductivity of at least about 3.5 mS/cm. In some composition embodiments, the composition has an ionic conductivity of at least about 4.0 mS/cm. In some composition embodiments, the composition has an ionic conductivity of at least about 4.3 mS/cm.

In some composition embodiments, the composition has an electronic conductivity of no more than about 10⁻⁶ S/cm. In some composition embodiments, the composition has an electronic conductivity of no more than about 10⁻⁷ S/cm. In some composition embodiments, the composition has an electronic conductivity of no more than about 10⁻⁸ S/cm. In some composition embodiments, the composition has an electronic conductivity of no more than about 10⁻⁹ S/cm.

According to one aspect of the present disclosure, provided in certain embodiments herein are compositions comprising sodium cation, dicarbaundecaborate anion and an additional anion, wherein the composition has an ionic conductivity that is higher than that of sodium dicarbaundecaborate.

In some composition embodiments, the composition has an ionic conductivity of at least about 0.05 mS/cm. In some composition embodiments, the composition has an ionic conductivity of at least about 0.1 mS/cm. In some composition embodiments, the composition has an ionic conductivity of at least about 0.5 mS/cm. In some composition embodiments, the composition has an ionic conductivity of at least about 1.0 mS/cm. In some composition embodiments, the composition has an ionic conductivity of at least about 1.5 mS/cm. In some composition embodiments, the composition has an ionic conductivity of at least about 2.0 mS/cm.

In some composition embodiments, the composition has an ionic conductivity of at least about 2.5 mS/cm. In some composition embodiments, the composition has an ionic conductivity of at least about 2.7 mS/cm. In some composition embodiments, the composition has an ionic conductivity of at least about 3.0 mS/cm. In some composition embodiments, the composition has an ionic conductivity of at least about 3.5 mS/cm. In some composition embodiments, the composition has an ionic conductivity of at least about 4.0 mS/cm. In some composition embodiments, the composition has an ionic conductivity of at least about 4.3 mS/cm.

In some composition embodiments, the composition has an electronic conductivity of no more than about 10⁻⁶ S/cm. In some composition embodiments, the composition has an electronic conductivity of no more than about 10⁻⁷ S/cm, preferably no more than about 10⁻⁸ S/cm, and more preferably no more than about 10⁻⁹ S/cm.

In some composition embodiments, the dicarbaundecaborate anion comprises 7,8-dicarbaundecaborate anion ([7,8-C₂B₉H₁₂]⁻). In some composition embodiments, the dicarbaundecaborate anion is 7,8-dicarbaundecaborate anion ([7,8-C₂B₉H₁₂]⁻).

In some composition embodiments, the dicarbaundecaborate anion comprises 7,9-dicarbaundecaborate anion ([7,9-C₂B₉H₁₂]⁻). In some composition embodiments, the dicarbaundecaborate anion is 7,9-dicarbaundecaborate anion ([7,9-C₂B₉H₁₂]⁻).

In some composition embodiments, the dicarbaundecaborate anion comprises a mixture of 7,8-dicarbaundecaborate anion ([7,8-C₂B₉H₁₂]⁻) and 7,9-dicarbaundecaborate anion ([7,9-C₂B₉H₁₂]⁻). In some composition embodiments, the dicarbaundecaborate anion is a mixture of 7,8-dicarbaundecaborate anion ([7,8-C₂B₉H₁₂]⁻) and 7,9-dicarbaundecaborate anion ([7,9-C₂B₉H₁₂]⁻).

According to one aspect of the present disclosure, provided in certain embodiments herein are electrolytes comprising the compound or the composition disclosed herein.

In some electrolyte embodiments, the electrolyte further comprises a negative electrode material. In some electrolyte embodiments, the negative electrode material is a metal anode material, a metal elemental anode material, a nonmetal elemental anode material, an alloy material, or a transition metal oxide material. In some electrolyte embodiments, the negative electrode material is a Na—Sn alloy. In some electrolyte embodiments, the negative electrode material is a Na—Sn (2:1) alloy.

In some electrolyte embodiments, the electrolyte further comprises a conductive material. In some electrolyte embodiments, the conductive material is selected from the group consisting of graphite, carbon black, carbon fibers or metal fibers, metal powder, conductive whiskers, conductive metal oxide, activated carbon, polyphenylene derivatives, and combinations thereof. In some electrolyte embodiments, the conductive material is selected from the group consisting of natural graphite, artificial graphite, Super-P, acetylene black, Ketjen black, channel black, furnace black, lamp black, thermal black, Denka black, vapor grown carbon fibers, and combinations thereof.

In some electrolyte embodiments, the electrolyte further comprises a binder resin. In some electrolyte embodiments, the binder resin is selected from the group consisting of polyvinylidene difluoride, polyvinylidene fluoride-co-hexafluoropropylene, polyvinylidene fluoride-co-trichloroethylene, polymethylmethacrylate, polyethylhexyl acrylate, polybutylacrylate, polyacrylonitrile, polyvinylpyrrolidone, polyvinylacetate, polyethylene-co-vinyl acetate, polyethylene oxide, polyarylate, cellulose acetate, cellulose acetate butyrate, cellulose acetate propionate, cyanoethylpullulan, cyanoethylpolyvinylalcohol, cyanoethylcellulose, cyanoethylsucrose, pullulan and carboxyl methyl cellulose, polyacrylic acid, polyacrylic acid salt derivatives, and combinations thereof.

According to one aspect of the present disclosure, provided in certain embodiments herein are batteries comprising: a) a negative electrode, b) a positive electrode and c) the electrolyte disclosed herein.

In some battery embodiments, the electrolyte is an anolyte.

In some battery embodiments, the positive electrode comprises sodium transition metal oxide active material as a positive electrode active material, and preferably the transition metal comprises at least one of Cr, Mn, Fe, Ni or V. In some battery embodiments, the positive electrode comprises Na₃V₂(PO₄)₃ (NVP). In some battery embodiments, the positive electrode comprises NaCrO₂ cathode (NCO).

In some battery embodiments, the negative electrode material is a metal anode material, a nonmetal elemental anode material, an alloy material, or a transition metal oxide material. In some battery embodiments, the negative electrode material is a Na—Sn alloy. In some battery embodiments, the negative electrode material is a Na—Sn (2:1) alloy.

In some battery embodiments, the negative electrode and/or the positive electrode further comprising a conductive material. In some battery embodiments, the conductive material is selected from the group consisting of graphite, carbon black, carbon fibers or metal fibers, metal powder, conductive whiskers, conductive metal oxide, activated carbon, polyphenylene derivatives, and combinations thereof. In some battery embodiments, the conductive material is selected from the group consisting of natural graphite, artificial graphite, super-p, acetylene black, ketjen black, channel black, furnace black, lamp black, thermal black, denka black, vapor grown carbon fibre, and combinations thereof.

In some battery embodiments, the negative electrode and/or the positive electrode further comprises a binder resin. In some battery embodiments, the binder resin is selected from the group consisting of polyvinylidene difluoride, polyvinylidene fluoride-co-hexafluoropropylene, polyvinylidene fluoride-co-trichloroethylene, polymethylmethacrylate, polyethylhexyl acrylate, polybutylacrylate, polyacrylonitrile, polyvinylpyrrolidone, polyvinylacetate, polyethylene-co-vinyl acetate, polyethylene oxide, polyarylate, cellulose acetate, cellulose acetate butyrate, cellulose acetate propionate, cyanoethylpullulan, cyanoethylpolyvinylalcohol, cyanoethylcellulose, cyanoethylsucrose, pullulan and carboxyl methyl cellulose, polyacrylic acid, polyacrylic acid salt derivatives, and combinations thereof.

In some battery embodiments, the battery further comprises a catholyte. In some battery embodiments, the catholyte comprises a reference closo-borate. In some battery embodiments, the catholyte comprises a reference halide.

In some battery embodiments, the battery exhibits no Na plating at 3C. In some battery embodiments, the battery exhibits no Na plating at 4C. In some battery embodiments, the battery exhibits no Na plating at 5C.

In some battery embodiments, the battery has a Coulombic efficiency of at least 60%, preferably at least 90%, and more preferably at least 95% for the first 20 cycles. In some battery embodiments, the battery has a Coulombic efficiency of at least 60%, preferably at least 90%, and more preferably at least 95% for the first 15 cycles. In some battery embodiments, the battery has a Coulombic efficiency of at least 60%, preferably at least 90%, and more preferably at least 95% for the first 10 cycles. In some battery embodiments, the battery has a Coulombic efficiency of at least 60%, preferably at least 90%, and more preferably at least 95% for the first 5 cycles. In some battery embodiments, the battery has a Coulombic efficiency of at least 60%, preferably at least 90%, and more preferably at least 95% for the first 2 cycles. In some battery embodiments, the battery has a Coulombic efficiency of at least 60%, preferably at least 90%, and more preferably at least 95% for the first cycle. In some battery embodiments, the battery has a negative electrode capacity to positive electrode capacity (N/P) ratio of 0.1 to 30.0.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification.

### BRIEF DESCRIPTION OF THE DRAWINGS

It is to be expressly understood that the drawings are for the purpose of illustration and description only and are not intended as a definition of the limits of the invention.

FIG. 1 shows a X-ray diffraction pattern of the electrolyte Na₂₋ₓ([7,8-C₂B₉H₁₂]⁻)ₓ(B₁₂H₁₂)₁₋ₓ, where x=0.33, 0.5, 0.66, and 0.75, which corresponds to C278_{y}, where y=0.5, 1, 2, and 3, additionally with references for the precursors Na([7,8-C₂B₉H₁₂]⁻) and Na₂B₁₂H₁₂. This shows that processing of the mixture of Na([7,8-C₂B₉H₁₂]⁻):(Na₂B₁₂H₁₂) yields a new compound.

FIG. 2 shows a X-ray diffraction pattern of the electrolyte Na₂₋ₓ([7,9-C₂B₉H₁₂]⁻)ₓ(B₁₂H₁₂)₁₋ₓ, where x=0.33, 0.5, 0.66, and 0.75, which corresponds to C279_{y}, where y=0.5, 1, 2, and 3, additionally with references for the precursors Na([7,9-C₂B₉H₁₂]⁻) and Na₂B₁₂H₁₂. This shows that processing of the mixture of Na([7,9-C₂B₉H₁₂]⁻):(Na₂B₁₂H₁₂) yields a new compound.

FIG. 3 shows the ionic conductivity of the electrolyte C278_{y}, where y=0.5, 1, 2, and 3, All the molar ratios show a high conductivity, values suitable for use in sodium secondary batteries.

FIG. 4 shows the ionic conductivity of the electrolyte C279_{y}, where y=0.5, 1, 2, and 3, All the molar ratios show a high conductivity, values suitable for use in sodium secondary batteries.

FIG. 5 shows the electronic conductivity of the electrolyte C279₃. The low electronic conductivity means that this material is primarily an ionic conductor, and thus a sodium ion conductor, suitable for use in secondary batteries.

FIG. 6 shows the X-ray diffraction pattern of the electrolyte C279₃ taken after every 1 hour of processing. Evident is that the target sodium-ion conductor is synthesized after just 1 hour of processing; no changes to the structure are observed after further processing.

FIG. 7 shows the ionic conductivity of the electrolyte C279₃, taken after every 1 hour of processing. Along with FIG. 6, it is evident that the target sodium-ion conductor is synthesized after just 1 hour of processing; no changes with regards to its structure nor significant changes in its ionic conductivity are observed.

FIG. 8 shows the ionic conductivity of the electrolyte precursor Na([7,8-C₂B₉H₁₂]⁻). The ionic conductivity value is 0.0001 mS/cm, orders of magnitude lower than the electrolyte C278_{y}. Thus, a mixture of Na([7,8-C₂B₉H₁₂]⁻) and Na₂B₁₂H₁₂ clearly produces a compound with superior properties than their precursors.

FIG. 9 shows the ionic conductivity of the electrolyte precursor Na([7,9-C₂B₉H₁₂]⁻). The ionic conductivity value is 0.020 mS/cm, orders of magnitude lower than the electrolyte C279_{y}. Thus, a mixture of Na([7,9-C₂B₉H₁₂]⁻) and Na₂B₁₂H₁₂ clearly produces a compound with superior properties than their precursors.

FIG. 10 shows the rate performance of the sodium secondary battery, comprising of Na—Sn 2:1 as the anode, a reference carbadodecaborate electrolyte, and a Na₃V₂(PO₄)₃ cathode (NVP). Na plating, or soft shorting, is observed on the third cycle at a rate of 3C.

FIG. 11 shows the rate performance of the sodium secondary battery, comprising of Na—Sn 2:1 as the anode, C279₃ as the anolyte, a reference borate as the catholyte, and a Na₃V₂(PO₄)₃ cathode (NVP). Soft shorting was not observed at a rate of 3C, 4C, or 5C, showing that the addition of C279₃ increased the rate performance of the sodium secondary battery.

FIG. 12 shows symmetric cell data, where the electrolyte C279₃ is sandwiched between Na—Sn 2:1 electrodes. For comparison, the same test using a reference borate is included. Both configurations had 100 μA applied over 1 hr (charge) then a subsequent discharge of 100 μA applied over 1 hr, for a total duration of 48 hrs. Both borates show similar behavior, in that impedance does not grow over time (which would have been indicated by a corresponding increase in the amplitude of the voltage response). This means that both compounds are suitable as anolytes and stable at the anode side.

FIG. 13 shows the cycling performance of a sodium secondary battery, comprising of Na—Sn 2:1 as the anode, C279₃ as the anolyte, a reference halide as the catholyte, and a Na₃V₂(PO₄)₃ cathode (NVP). The first 20 cycles are shown (both the voltage vs. specific capacity, and specific capacity vs. cycle number). This shows that C279₃ is suitable as an anolyte and can be used with different catholytes in a sodium secondary battery.

FIG. 14 shows the cycling performance of a sodium secondary battery, comprising of Na—Sn 2:1 as the anode, C279₃ as the anolyte, a reference halide as the catholyte, and a NaCrO₂ cathode (NCO). The first 20 cycles are shown (both the voltage vs. specific capacity, and specific capacity vs. cycle number). Along with FIG. 13, this shows that C279₃ is suitable as an anolyte, and can be used with not only different catholytes but different cathodes in a sodium secondary battery.

FIG. 15 shows a comparison of the first cycle of a sodium secondary battery, comprising of Na—Sn 2:1 as the anode, C279₃ as the anolyte, a reference borate as the catholyte, and a NVP as the cathode, and another battery comprising of Na—Sn 2:1 as the anode, a reference borate as the electrolyte, and a NVP as the cathode. A higher first cycle Coulombic efficiency is observed (95.2% to 85.5%), which shows show that C279₃ is a suitable as an anolyte and its inclusion improves the overall stability of the secondary battery.

FIG. 16 shows another comparison of the first cycle of a sodium secondary battery, comprising of Na—Sn 2:1 as the anode, C279₃ as the anolyte, a reference halide as the catholyte, and a NVP as the cathode, and another battery comprising of Na—Sn 2:1 as the anode, a reference halide as the electrolyte, and a NVP as the cathode. A higher first cycle Coulombic efficiency is observed (97.9% to 96.4%), which shows show that C279₃ is suitable as an anolyte and its inclusion improves the overall stability of the secondary battery.

### DETAILED DESCRIPTION OF THE INVENTION

Hereinafter, the present disclosure will be described in detail. Prior to the description, it should be understood that the terms or words used in the specification and the appended claims should not be construed as limited to general and dictionary meanings, but rather interpreted based on the meanings and concepts corresponding to the technical aspects of the present disclosure on the basis of the principle that the inventor is allowed to define terms appropriately for the best explanation. Therefore, the embodiments described herein and the elements shown in the drawings is just a most preferred embodiment of the present disclosure, but not intended to fully describe the technical aspects of the present disclosure, so it should be understood that other equivalents and modifications could have been made thereto at the time the application was filed.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The terms “about” and “essentially” are used herein in the sense of at, or nearly at, when given the manufacturing and material tolerances inherent in the stated circumstances and are used to prevent the unscrupulous infringer from unfairly taking advantage of the present disclosure where exact or absolute figures are stated as an aid to understanding the present disclosure.

“A and/or B” when used in this specification, specifies “either A or B or both”.

Sodium all-solid-state batteries typically comprise a cathode, i.e. the positive electrode, for example a sodium transition metal oxide, an anode, i.e. the negative electrode, for example Na metal, Na alloys, or others, and a solid sodium-ion conducting solid electrolyte, which ensures Na ion transport between the two electrodes.

The present disclosure recognizes that some solid electrolytes have been sulfide-based, but sulfides sometime have limitations: one, sulfides have a narrow electrochemical window or stability window. Going above/below this window during battery charging/discharging leads to oxidation/reduction, respectively, and thus, degradation of the electrolyte, which leads to poor battery performance, cycle life, and calendar life. Degradation can either occur spontaneously (a chemical reaction) or during cycling (an electrochemical reaction). A wider stability window enables the electrolyte to be compatible with the anode, cathode, or both.

The present disclosure further recognizes that a new class of sodium-ion conductors, halides, have much higher oxidative stability than sulfides and have been demonstrated to be stable and compatible, both chemically and electrochemically, with certain transition metal oxide cathodes. With chloride-based sodium-ion conductors, it is possible to extend the cycle life of the solid-state batteries.

The present disclosure further recognizes that chlorine-based halides sometimes have their own drawbacks. One, they generally have lower conductivity than the sulfides, which lowers the rate capability of the battery, and two, they still have stability and degradation issues at the anode or negative electrode side, where they have been shown to reduce and degrade even more readily and severely than sulfides.

Provided herein are electrolyte compounds, compositions, and composite materials that have desirable properties such as high conductivity, the ability to withstand a higher current density, and Coulombic efficiency. It will be readily appreciated that these and other objects and advantages of the present disclosure may be realized by means or methods described in the appended claims and a combination thereof.

A second aspect of the present disclosure relates to a sodium secondary battery in the first aspect wherein the electrolyte contains the compounds, compositions, and composite materials disclosed herein.

A third aspect of the present disclosure relates to a sodium secondary battery in the second aspect wherein the electrolyte in contact with the anode, or anolyte, contains the compounds, compositions, and composite materials disclosed herein, and the electrolyte in contact with the cathode, or catholyte, is another material, either another borate or another halide. The anolyte and catholyte may also contain other materials such as conductive carbon additives or binders in a composite with the respective anode and cathode materials.

A fourth aspect of the present disclosure relates to the sodium secondary battery in any of the second to third aspects wherein the negative electrode comprises an anode material that is metallic, elemental, an alloy, carbon-based, or a transition metal oxide-based host.

A fifth aspect of the present disclosure relates to the sodium secondary battery in any one of the second to fourth aspects wherein the negative electrode material layer further comprises at least one of a binder resin, a conductive carbon additive material or the compounds, compositions, and composite materials disclosed herein.

A sixth aspect of the present disclosure relates to the sodium secondary battery in any one of the second to fifth aspects wherein the positive electrode comprises a positive electrode active material layer, the positive electrode active material layer comprises a sodium transition metal oxide or sodium ferrocyanide as a positive electrode active material, and the transition metal comprises at least one of Cr, Mn, Fe, Ni or V.

A seventh aspect of the present disclosure relates to the sodium secondary battery in any one of the second to sixth aspects wherein the positive electrode active material layer further comprises at least one of a binder resin, a conductive material or a solid electrolyte.

An eighth aspect of the present disclosure relates to the sodium secondary battery in any one of the second to seventh aspects wherein the positive electrode active material layer is obtained using the positive electrode active material, the conductive material and the binder resin by a manufacturing method according to a dry mixing process without a solvent.

A ninth aspect of the present disclosure relates to the sodium secondary battery in any one of the second to eighth aspects wherein the battery has a negative electrode capacity to positive electrode capacity (N/P) ratio of 0.1 to 30.0.

Hereinafter, the compound, composition, composite material, electrode, battery, and technical effects of the present disclosure will be described in detail.

### Compound

The present disclosure is directed to a new sodium-ion conducting electrolyte compound, a mixture of the sodium dicarbaundecaborate (which contains the [C₂B₉H₁₂]⁻ anion) NaC₂B₉H₁₂ and the sodium dodecahydrododecaborate Na₂B₁₂H₁₂. Generally, the compound has the formula Na₂₋ₓ(C₂B₉H₁₂)ₓ(B₁₂H₁₂)₁₋ₓ, where 0<x<1. More specifically, the NaC₂B₉H₁₂ has two variants: Na[7,8-C₂B₉H₁₂], and Na[7,9-C₂B₉H₁₂], thus, the electrolyte has two variants, Na₂₋ₓ([7,8-C₂B₉H₁₂]⁻)ₓ(B₁₂H₁₂)₁₋ₓ and Na₂₋ₓ([7,9-C₂B₉H₁₂]⁻)ₓ(B₁₂H₁₂)₁₋ₓ, where 0<x<1. These electrolytes will be abbreviated C278_{y} and C279_{y}, where y refers to the molar ratio Na[7,8-C₂B₉H₁₂]:Na₂B₁₂H₁₂, or Na[7,9-C₂B₉H₁₂]:Na₂B₁₂H₁₂, respectively; i.e. if x=0.33, yielding Na_{1.66}([7,8-C₂B₉H₁₂]⁻)_{0.33}(B₁₂H₁₂)_{0.66}, the molar ratio between Na[7,8-C₂B₉H₁₂] and Na₂B₁₂H₁₂ is 0.33/0.66, or 0.5/1, thus y=0.5, and the abbreviation C2780.5 is equivalent, and i.e. if x=0.5, yielding Na_{1.5}([7,8-C₂B₉H₁₂]⁻)_{0.5}(B₁₂H₁₂)_{0.5}, the molar ratio between Na[7,8-C₂B₉H₁₂] and Na₂B₁₂H₁₂ is 0.5/0.5, or 1, thus y=1, and the abbreviation C278₁ is equivalent. In summary,

$$y = \frac{x}{1 - x} ,$$

where 0<x<1. In some embodiment, the molar ratios that were tested were y=0.5, 1, 2, 3 (corresponding to x=0.33, 0.5, 0.66, 0.75).

In some compound embodiments, x is from 0.2 to 0.4. In some compound embodiments, x is about 0.33.

In some compound embodiments, x is from 0.4 to 0.6. In some compound embodiments, x is from about 0.5.

In some compound embodiments, x is from 0.6 to 0.7. In some compound embodiments, x is about 0.67.

In some compound embodiments, x is from 0.7 to 0.9. In some compound embodiments, x is about 0.75.

In some compound embodiments, the C₂B₉H₁₂ comprises 7,8-C₂B₉H₁₂. In some compound embodiments, the C₂B₉H₁₂ is 7,8-C₂B₉H₁₂.

In some compound embodiments, the C₂B₉H₁₂ comprises 7,9-C₂B₉H₁₂. In some compound embodiments, the C₂B₉H₁₂ is 7,9-C₂B₉H₁₂.

In some compound embodiments, the C₂B₉H₁₂ comprises a mixture of 7,8-C₂B₉H₁₂ and 7,9-C₂B₉H₁₂. In some compound embodiments, the C₂B₉H₁₂ is a mixture of 7,8-C₂B₉H₁₂ and 7,9-C₂B₉H₁₂.

Notably, those compounds demonstrated similar properties, notably high ionic conductivity and anode stability.

### Compositions

According to one aspect of the present disclosure, provided in certain embodiments herein are compositions comprising, consisting essentially of, or consisting of, sodium cation (Na⁺), dicarbaundecaborate anion ([C₂B₉H₁₂]⁻), and dodecahydrododecaborate anion ([B₁₂H₁₂]²⁻).

In some composition embodiments, the molar ratio between dicarbaundecaborate anion and dodecahydrododecaborate anion is from 0.01 to 0.7. In some composition embodiments, the molar ratio between dicarbaundecaborate anion and dodecahydrododecaborate anion is about 0.5.

In some composition embodiments, the molar ratio between dicarbaundecaborate anion and dodecahydrododecaborate anion is from 0.7 to 1.5. In some composition embodiments, the molar ratio between dicarbaundecaborate anion and dodecahydrododecaborate anion is about 1.0.

In some composition embodiments, the molar ratio between dicarbaundecaborate anion and dodecahydrododecaborate anion is from 1.5 to 2.5. In some composition embodiments, the molar ratio between dicarbaundecaborate anion and dodecahydrododecaborate anion is about 2.0.

In some composition embodiments, the molar ratio between dicarbaundecaborate anion and dodecahydrododecaborate anion is from 2.5 to 10. In some composition embodiments, the molar ratio between dicarbaundecaborate anion and dodecahydrododecaborate anion is about 3.0.

In some composition embodiments, the dicarbaundecaborate anion comprises 7,8-dicarbaundecaborate anion ([7,8-C₂B₉H₁₂]⁻). In some composition embodiments, the dicarbaundecaborate anion is 7,8-dicarbaundecaborate anion ([7,8-C₂B₉H₁₂]⁻).

In some composition embodiments, the dicarbaundecaborate anion comprises 7,9-dicarbaundecaborate anion ([7,9-C₂B₉H₁₂]⁻). In some composition embodiments, the dicarbaundecaborate anion is 7,9-dicarbaundecaborate anion ([7,9-C₂B₉H₁₂]⁻).

In some composition embodiments, the dicarbaundecaborate anion comprises a mixture of 7,8-dicarbaundecaborate anion ([7,8-C₂B₉H₁₂]⁻) and 7,9-dicarbaundecaborate anion ([7,9-C₂B₉H₁₂]⁻). In some composition embodiments, the dicarbaundecaborate anion is a mixture of 7,8-dicarbaundecaborate anion ([7,8-C₂B₉H₁₂]⁻) and 7,9-dicarbaundecaborate anion ([7,9-C₂B₉H₁₂]⁻).

In some composition embodiments, the composition has an ionic conductivity of at least about 0.05 mS/cm. In some composition embodiments, the composition has an ionic conductivity of at least about 0.1 mS/cm. In some composition embodiments, the composition has an ionic conductivity of at least about 0.5 mS/cm. In some composition embodiments, the composition has an ionic conductivity of at least about 1.0 mS/cm. In some composition embodiments, the composition has an ionic conductivity of at least about 1.5 mS/cm. In some composition embodiments, the composition has an ionic conductivity of at least about 2.0 mS/cm.

In some composition embodiments, the composition has an ionic conductivity of at least about 2.5 mS/cm. In some composition embodiments, the composition has an ionic conductivity of at least about 2.7 mS/cm. In some composition embodiments, the composition has an ionic conductivity of at least about 3.0 mS/cm. In some composition embodiments, the composition has an ionic conductivity of at least about 3.5 mS/cm. In some composition embodiments, the composition has an ionic conductivity of at least about 4.0 mS/cm. In some composition embodiments, the composition has an ionic conductivity of at least about 4.3 mS/cm.

In some composition embodiments, the composition has an electronic conductivity of no more than about 10⁻⁶ S/cm. In some composition embodiments, the composition has an electronic conductivity of no more than about 10⁻⁷ S/cm. In some composition embodiments, the composition has an electronic conductivity of no more than about 10⁻⁸ S/cm, and preferably no more than about 10⁻⁹ S/cm.

According to one aspect of the present disclosure, provided in certain embodiments herein are compositions formed by a chemical reaction between sodium dicarbaundecaborate (NaC₂B₉H₁₂) and sodium dodecahydrododecaborate (Na₂B₁₂H₁₂).

In some composition embodiments, the chemical reaction is a one-step reaction. In some composition embodiments, the chemical reaction is completed within 3 hours. In some composition embodiments, the chemical reaction is completed within 2 hours. In some composition embodiments, the chemical reaction is completed within 1 hours.

In some composition embodiments, the molar ratio between dicarbaundecaborate anion and dodecahydrododecaborate anion is from 0.01 to 0.7. In some composition embodiments, the molar ratio between dicarbaundecaborate anion and dodecahydrododecaborate anion is about 0.5.

In some composition embodiments, the molar ratio between dicarbaundecaborate anion and dodecahydrododecaborate anion is from 0.7 to 1.5. In some composition embodiments, the molar ratio between dicarbaundecaborate anion and dodecahydrododecaborate anion is about 1.0.

In some composition embodiments, the molar ratio between dicarbaundecaborate anion and dodecahydrododecaborate anion is from 1.5 to 2.5. In some composition embodiments, the molar ratio between dicarbaundecaborate anion and dodecahydrododecaborate anion is about 2.0.

In some composition embodiments, the molar ratio between dicarbaundecaborate anion and dodecahydrododecaborate anion is from 2.5 to 10. In some composition embodiments, the molar ratio between dicarbaundecaborate anion and dodecahydrododecaborate anion is about 3.0.

In some composition embodiments, the dicarbaundecaborate anion comprises 7,8-dicarbaundecaborate anion ([7,8-C₂B₉H₁₂]⁻). In some composition embodiments, the dicarbaundecaborate anion is 7,8-dicarbaundecaborate anion ([7,8-C₂B₉H₁₂]⁻).

In some composition embodiments, the dicarbaundecaborate anion comprises 7,9-dicarbaundecaborate anion ([7,9-C₂B₉H₁₂]⁻). In some composition embodiments, the dicarbaundecaborate anion is 7,9-dicarbaundecaborate anion ([7,9-C₂B₉H₁₂]⁻).

In some composition embodiments, the dicarbaundecaborate anion comprises a mixture of 7,8-dicarbaundecaborate anion ([7,8-C₂B₉H₁₂]⁻) and 7,9-dicarbaundecaborate anion ([7,9-C₂B₉H₁₂]⁻). In some composition embodiments, the dicarbaundecaborate anion is a mixture of 7,8-dicarbaundecaborate anion ([7,8-C₂B₉H₁₂]⁻) and 7,9-dicarbaundecaborate anion ([7,9-C₂B₉H₁₂]⁻).

In some composition embodiments, the composition has an ionic conductivity of at least about 0.05 mS/cm. In some composition embodiments, the composition has an ionic conductivity of at least about 0.1 mS/cm. In some composition embodiments, the composition has an ionic conductivity of at least about 0.5 mS/cm. In some composition embodiments, the composition has an ionic conductivity of at least about 1.0 mS/cm. In some composition embodiments, the composition has an ionic conductivity of at least about 1.5 mS/cm. In some composition embodiments, the composition has an ionic conductivity of at least about 2.0 mS/cm.

In some composition embodiments, the composition has an ionic conductivity of at least about 2.5 mS/cm. In some composition embodiments, the composition has an ionic conductivity of at least about 2.7 mS/cm. In some composition embodiments, the composition has an ionic conductivity of at least about 3.0 mS/cm. In some composition embodiments, the composition has an ionic conductivity of at least about 3.5 mS/cm. In some composition embodiments, the composition has an ionic conductivity of at least about 4.0 mS/cm. In some composition embodiments, the composition has an ionic conductivity of at least about 4.3 mS/cm.

In some composition embodiments, the composition has an electronic conductivity of no more than about 10⁻⁶ S/cm. In some composition embodiments, the composition has an electronic conductivity of no more than about 10⁻⁷ S/cm. In some composition embodiments, the composition has an electronic conductivity of no more than about 10⁻⁸ S/cm. In some composition embodiments, the composition has an electronic conductivity of no more than about 10⁻⁹ S/cm.

According to one aspect of the present disclosure, provided in certain embodiments herein are compositions comprising sodium cation, dicarbaundecaborate anion and an additional anion, wherein the composition has an ionic conductivity that is higher than that of sodium dicarbaundecaborate.

In some composition embodiments, the composition has an ionic conductivity of at least about 0.05 mS/cm. In some composition embodiments, the composition has an ionic conductivity of at least about 0.1 mS/cm. In some composition embodiments, the composition has an ionic conductivity of at least about 0.5 mS/cm. In some composition embodiments, the composition has an ionic conductivity of at least about 1.0 mS/cm. In some composition embodiments, the composition has an ionic conductivity of at least about 1.5 mS/cm. In some composition embodiments, the composition has an ionic conductivity of at least about 2.0 mS/cm.

In some composition embodiments, the composition has an ionic conductivity of at least about 2.5 mS/cm. In some composition embodiments, the composition has an ionic conductivity of at least about 2.7 mS/cm. In some composition embodiments, the composition has an ionic conductivity of at least about 3.0 mS/cm. In some composition embodiments, the composition has an ionic conductivity of at least about 3.5 mS/cm. In some composition embodiments, the composition has an ionic conductivity of at least about 4.0 mS/cm. In some composition embodiments, the composition has an ionic conductivity of at least about 4.3 mS/cm.

In some composition embodiments, the composition has an electronic conductivity of no more than about 10⁻⁶ S/cm. In some composition embodiments, the composition has an electronic conductivity of no more than about 10⁻⁷ S/cm, preferably no more than about 10⁻⁸ S/cm, and more preferably no more than about 10⁻⁹ S/cm.

In some composition embodiments, the dicarbaundecaborate anion comprises 7,8-dicarbaundecaborate anion ([7,8-C₂B₉H₁₂]⁻). In some composition embodiments, the dicarbaundecaborate anion is 7,8-dicarbaundecaborate anion ([7,8-C₂B₉H₁₂]⁻).

In some composition embodiments, the dicarbaundecaborate anion comprises 7,9-dicarbaundecaborate anion ([7,9-C₂B₉H₁₂]⁻). In some composition embodiments, the dicarbaundecaborate anion is 7,9-dicarbaundecaborate anion ([7,9-C₂B₉H₁₂]⁻).

In some composition embodiments, the dicarbaundecaborate anion comprises a mixture of 7,8-dicarbaundecaborate anion ([7,8-C₂B₉H₁₂]⁻) and 7,9-dicarbaundecaborate anion ([7,9-C₂B₉H₁₂]⁻). In some composition embodiments, the dicarbaundecaborate anion is a mixture of 7,8-dicarbaundecaborate anion ([7,8-C₂B₉H₁₂]⁻) and 7,9-dicarbaundecaborate anion ([7,9-C₂B₉H₁₂]⁻).

### Electrolytes

According to one aspect of the present disclosure, provided in certain embodiments herein are electrolytes comprising the compound or the composition disclosed herein.

In some electrolyte embodiments, the electrolyte further comprises a negative electrode material. In some electrolyte embodiments, the negative electrode material is a metal anode material, a metal elemental anode material, a nonmetal elemental anode material, an alloy material, or a transition metal oxide material. In some electrolyte embodiments, the negative electrode material is a Na—Sn alloy. In some electrolyte embodiments, the negative electrode material is a Na—Sn (2:1) alloy.

In some electrolyte embodiments, the electrolyte further comprises a conductive material. In some electrolyte embodiments, the conductive material is selected from the group consisting of graphite, carbon black, carbon fibers or metal fibers, metal powder, conductive whiskers, conductive metal oxide, activated carbon, polyphenylene derivatives, and combinations thereof. In some electrolyte embodiments, the conductive material is selected from the group consisting of natural graphite, artificial graphite, Super-P, acetylene black, Ketjen black, channel black, furnace black, lamp black, thermal black, Denka black, vapor grown carbon fibers, and combinations thereof.

In some electrolyte embodiments, the electrolyte further comprises a binder resin. In some electrolyte embodiments, the binder resin is selected from the group consisting of polyvinylidene difluoride, polyvinylidene fluoride-co-hexafluoropropylene, polyvinylidene fluoride-co-trichloroethylene, polymethylmethacrylate, polyethylhexyl acrylate, polybutylacrylate, polyacrylonitrile, polyvinylpyrrolidone, polyvinylacetate, polyethylene-co-vinyl acetate, polyethylene oxide, polyarylate, cellulose acetate, cellulose acetate butyrate, cellulose acetate propionate, cyanoethylpullulan, cyanoethylpolyvinylalcohol, cyanoethylcellulose, cyanoethylsucrose, pullulan and carboxyl methyl cellulose, polyacrylic acid, polyacrylic acid salt derivatives, and combinations thereof.

### Battery

According to one aspect of the present disclosure, provided in certain embodiments herein are batteries comprising: a) a negative electrode, b) a positive electrode and c) the electrolyte disclosed herein.

In some battery embodiments, the electrolyte is an anolyte.

In some battery embodiments, the positive electrode comprises sodium transition metal oxide active material as a positive electrode active material, and preferably the transition metal comprises at least one of Cr, Mn, Fe, Ni or V. In some battery embodiments, the positive electrode comprises Na₃V₂(PO₄)₃ (NVP). In some battery embodiments, the positive electrode comprises NaCrO₂ cathode (NCO).

In some battery embodiments, the negative electrode material is a metal anode material, a nonmetal elemental anode material, an alloy material, or a transition metal oxide material. In some battery embodiments, the negative electrode material is a Na—Sn alloy. In some battery embodiments, the negative electrode material is a Na—Sn (2:1) alloy.

In some battery embodiments, the negative electrode and/or the positive electrode further comprising a conductive material. In some battery embodiments, the conductive material is selected from the group consisting of graphite, carbon black, carbon fibers or metal fibers, metal powder, conductive whiskers, conductive metal oxide, activated carbon, polyphenylene derivatives, and combinations thereof. In some battery embodiments, the conductive material is selected from the group consisting of natural graphite, artificial graphite, super-p, acetylene black, ketjen black, channel black, furnace black, lamp black, thermal black, denka black, vapor grown carbon fibre, and combinations thereof.

In some battery embodiments, the negative electrode and/or the positive electrode further comprises a binder resin. In some battery embodiments, the binder resin is selected from the group consisting of polyvinylidene difluoride, polyvinylidene fluoride-co-hexafluoropropylene, polyvinylidene fluoride-co-trichloroethylene, polymethylmethacrylate, polyethylhexyl acrylate, polybutylacrylate, polyacrylonitrile, polyvinylpyrrolidone, polyvinylacetate, polyethylene-co-vinyl acetate, polyethylene oxide, polyarylate, cellulose acetate, cellulose acetate butyrate, cellulose acetate propionate, cyanoethylpullulan, cyanoethylpolyvinylalcohol, cyanoethylcellulose, cyanoethylsucrose, pullulan and carboxyl methyl cellulose, polyacrylic acid, polyacrylic acid salt derivatives, and combinations thereof.

In some battery embodiments, the battery further comprises a catholyte. In some battery embodiments, the catholyte comprises a reference closo-borate. In some battery embodiments, the catholyte comprises a reference halide.

In some battery embodiments, the battery exhibits no Na plating at 3C. In some battery embodiments, the battery exhibits no Na plating at 4C. In some battery embodiments, the battery exhibits no Na plating at 5C.

In some battery embodiments, the battery has a Coulombic efficiency of at least 60%, preferably at least 90%, and more preferably at least 95% for the first 20 cycles. In some battery embodiments, the battery has a Coulombic efficiency of at least 60%, preferably at least 90%, and more preferably at least 95% for the first 15 cycles. In some battery embodiments, the battery has a Coulombic efficiency of at least 60%, preferably at least 90%, and more preferably at least 95% for the first 10 cycles. In some battery embodiments, the battery has a Coulombic efficiency of at least 60%, preferably at least 90%, and more preferably at least 95% for the first 5 cycles. In some battery embodiments, the battery has a Coulombic efficiency of at least 60%, preferably at least 90%, and more preferably at least 95% for the first 2 cycles. In some battery embodiments, the battery has a Coulombic efficiency of at least 60%, preferably at least 90%, and more preferably at least 95% for the first cycle. In some battery embodiments, the battery has a negative electrode capacity to positive electrode capacity (N/P) ratio of 0.1 to 30.0.

### Certain Technical Effects

The solid electrolyte according to the present disclosure has a high conductivity and high stability, enabling its use in a sodium secondary battery. It exhibits a higher first cycle Coulombic efficiency and rate capability, improving the stability and performance of the battery.

Additionally, due to its stability on the anode side, a solid electrolyte interphase (SEI) layer is not formed on the negative electrode interface, thereby preventing the loss of active material.

Additionally, the electrolyte is easy synthesized via a one-step process, so it is more readily scalable than other electrolyte classes and reduces the complexity of both material synthesis and in turn, battery fabrication.

With these features, the electrolyte according to the present disclosure has good suitable properties toward sodium secondary batteries with high energy density, durability, and high Coulombic efficiency.

### NON-LIMITING EMBODIMENTS

The following Embodiments are detailed by way of illustration only and are not to be construed as limiting in spirit or in scope, many modifications both in materials and in methods will be apparent to those skilled in the art.

1. A compound having a chemical formula of Na₂₋ₓ(C₂B₉H₁₂)ₓ(B₁₂H₁₂)₁₋ₓ, where 0<x<1.

2. The compound of Embodiment 1, wherein x is from 0.2 to 0.4.

3. The compound of Embodiment 1, wherein x is about 0.33.

4. The compound of Embodiment 1, wherein x is from 0.4 to 0.6.

5. The compound of Embodiment 1, wherein x is from about 0.5.

6. The compound of Embodiment 1, wherein x is from 0.6 to 0.7.

7. The compound of Embodiment 1, wherein x is about 0.67.

8. The compound of Embodiment 1, wherein x is from 0.7 to 0.9.

9. The compound of Embodiment 1, wherein x is about 0.75.

10. The compound of Embodiment 1-9, wherein the C₂B₉H₁₂ comprises 7,8-C₂B₉H₁₂.

11. The compound of Embodiment 1-9, wherein the C₂B₉H₁₂ is 7,8-C₂B₉H₁₂.

12. The compound of Embodiment 1-9, wherein the C₂B₉H₁₂ comprises 7,9-C₂B₉H₁₂.

13. The compound of Embodiment 1-9, wherein the C₂B₉H₁₂ is 7,9-C₂B₉H₁₂.

14. The compound of Embodiment 1-9, wherein the C₂B₉H₁₂ comprises a mixture of 7,8-C₂B₉H₁₂ and 7,9-C₂B₉H₁₂.

15. The compound of Embodiment 1-9, wherein the C₂B₉H₁₂ is a mixture of 7,8-C₂B₉H₁₂ and 7,9-C₂B₉H₁₂.

16. A composition comprising sodium cation (Na⁺), dicarbaundecaborate anion ([C₂B₉H₁₂]⁻), and dodecahydrododecaborate anion ([B₁₂H₁₂]²⁻).

17. A composition consisting essentially of sodium cation (Na⁺), dicarbaundecaborate anion ([C₂B₉H₁₂]⁻), and dodecahydrododecaborate anion ([B₁₂H₁₂]²⁻).

18. A composition consisting of sodium cation (Na⁺), dicarbaundecaborate anion ([C₂B₉H₁₂]⁻), and dodecahydrododecaborate anion ([B₁₂H₁₂]²⁻).

19. The composition of Embodiment 16-18, wherein the molar ratio between dicarbaundecaborate anion and dodecahydrododecaborate anion is from 0.01 to 0.7.

20. The composition of Embodiment 16-18, wherein the molar ratio between dicarbaundecaborate anion and dodecahydrododecaborate anion is about 0.5.

21. The composition of Embodiment 16-18, wherein the molar ratio between dicarbaundecaborate anion and dodecahydrododecaborate anion is from 0.7 to 1.5.

22. The composition of Embodiment 16-18, wherein the molar ratio between dicarbaundecaborate anion and dodecahydrododecaborate anion is about 1.0.

23. The composition of Embodiment 16-18, wherein the molar ratio between dicarbaundecaborate anion and dodecahydrododecaborate anion is from 1.5 to 2.5.

24. The composition of Embodiment 16-18, wherein the molar ratio between dicarbaundecaborate anion and dodecahydrododecaborate anion is about 2.0.

25. The composition of Embodiment 16-18, wherein the molar ratio between dicarbaundecaborate anion and dodecahydrododecaborate anion is from 2.5 to 10.

26. The composition of Embodiment 16-18, wherein the molar ratio between dicarbaundecaborate anion and dodecahydrododecaborate anion is about 3.0.

27. The composition of Embodiment 16-26, wherein the dicarbaundecaborate anion comprises 7,8-dicarbaundecaborate anion ([7,8-C₂B₉H₁₂]⁻).

28. The composition of Embodiment 16-26, wherein the dicarbaundecaborate anion is 7,8-dicarbaundecaborate anion ([7,8-C₂B₉H₁₂]⁻).

29. The composition of Embodiment 16-26, wherein the dicarbaundecaborate anion comprises 7,9-dicarbaundecaborate anion ([7,9-C₂B₉H₁₂]⁻).

30. The composition of Embodiment 16-26, wherein the dicarbaundecaborate anion is 7,9-dicarbaundecaborate anion ([7,9-C₂B₉H₁₂]⁻).

31. The composition of Embodiment 16-26, wherein the dicarbaundecaborate anion comprises a mixture of 7,8-dicarbaundecaborate anion ([7,8-C₂B₉H₁₂]⁻) and 7,9-dicarbaundecaborate anion ([7,9-C₂B₉H₁₂]⁻).

32. The composition of Embodiment 16-26, wherein the dicarbaundecaborate anion is a mixture of 7,8-dicarbaundecaborate anion ([7,8-C₂B₉H₁₂]⁻) and 7,9-dicarbaundecaborate anion ([7,9-C₂B₉H₁₂]⁻).

33. The composition of Embodiment 16-32, wherein the composition has an ionic conductivity of at least about 0.05 mS/cm.

34. The composition of Embodiment 16-32, wherein the composition has an ionic conductivity of at least about 0.1 mS/cm.

35. The composition of Embodiment 16-32, wherein the composition has an ionic conductivity of at least about 0.5 mS/cm.

36. The composition of Embodiment 16-32, wherein the composition has an ionic conductivity of at least about 1.0 mS/cm.

37. The composition of Embodiment 16-32, wherein the composition has an ionic conductivity of at least about 1.5 mS/cm.

38. The composition of Embodiment 16-32, wherein the composition has an ionic conductivity of at least about 2.0 mS/cm.

39. The composition of Embodiment 16-32, wherein the composition has an ionic conductivity of at least about 2.5 mS/cm.

40. The composition of Embodiment 16-32, wherein the composition has an ionic conductivity of at least about 2.7 mS/cm.

41. The composition of Embodiment 16-32, wherein the composition has an ionic conductivity of at least about 3.0 mS/cm.

42. The composition of Embodiment 16-32, wherein the composition has an ionic conductivity of at least about 3.5 mS/cm.

43. The composition of Embodiment 16-32, wherein the composition has an ionic conductivity of at least about 4.0 mS/cm.

44. The composition of Embodiment 16-32, wherein the composition has an ionic conductivity of at least about 4.3 mS/cm.

45. The composition of Embodiment 16-44, wherein the composition has an electronic conductivity of no more than about 10⁻⁶ S/cm.

46. The composition of Embodiment 16-44, wherein the composition has an electronic conductivity of no more than about 10⁻⁷ S/cm.

47. The composition of Embodiment 16-44, wherein the composition has an electronic conductivity of no more than about 10⁻⁸ S/cm, and preferably no more than about 10⁻⁹ S/cm.

48. A composition formed by a chemical reaction between sodium dicarbaundecaborate (NaC₂B₉H₁₂) and sodium dodecahydrododecaborate (Na₂B₁₂H₁₂).

49. The composition of Embodiment 48, wherein the chemical reaction is a one-step reaction.

50. The composition of Embodiment 48-49, wherein the chemical reaction is completed within 3 hours.

51. The composition of Embodiment 48-49, wherein the chemical reaction is completed within 2 hours.

52. The composition of Embodiment 48-49, wherein the chemical reaction is completed within 1 hours.

53. The composition of Embodiment 48-52, wherein the molar ratio between dicarbaundecaborate anion and dodecahydrododecaborate anion is from 0.01 to 0.7.

54. The composition of Embodiment 48-52, wherein the molar ratio between dicarbaundecaborate anion and dodecahydrododecaborate anion is about 0.5.

55. The composition of Embodiment 48-52, wherein the molar ratio between dicarbaundecaborate anion and dodecahydrododecaborate anion is from 0.7 to 1.5.

56. The composition of Embodiment 48-52, wherein the molar ratio between dicarbaundecaborate anion and dodecahydrododecaborate anion is about 1.0.

57. The composition of Embodiment 48-52, wherein the molar ratio between dicarbaundecaborate anion and dodecahydrododecaborate anion is from 1.5 to 2.5.

58. The composition of Embodiment 48-52, wherein the molar ratio between dicarbaundecaborate anion and dodecahydrododecaborate anion is about 2.0.

59. The composition of Embodiment 48-52, wherein the molar ratio between dicarbaundecaborate anion and dodecahydrododecaborate anion is from 2.5 to 10.

60. The composition of Embodiment 48-52, wherein the molar ratio between dicarbaundecaborate anion and dodecahydrododecaborate anion is about 3.0.

61. The composition of Embodiment 48-60, wherein the dicarbaundecaborate anion comprises 7,8-dicarbaundecaborate anion ([7,8-C₂B₉H₁₂]⁻).

62. The composition of Embodiment 48-60, wherein the dicarbaundecaborate anion is 7,8-dicarbaundecaborate anion ([7,8-C₂B₉H₁₂]⁻).

63. The composition of Embodiment 48-60, wherein the dicarbaundecaborate anion comprises 7,9-dicarbaundecaborate anion ([7,9-C₂B₉H₁₂]⁻).

64. The composition of Embodiment 48-60, wherein the dicarbaundecaborate anion is 7,9-dicarbaundecaborate anion ([7,9-C₂B₉H₁₂]⁻).

65. The composition of Embodiment 48-60, wherein the dicarbaundecaborate anion comprises a mixture of 7,8-dicarbaundecaborate anion ([7,8-C₂B₉H₁₂]⁻) and 7,9-dicarbaundecaborate anion ([7,9-C₂B₉H₁₂]⁻).

66. The composition of Embodiment 48-60, wherein the dicarbaundecaborate anion is a mixture of 7,8-dicarbaundecaborate anion ([7,8-C₂B₉H₁₂]⁻) and 7,9-dicarbaundecaborate anion ([7,9-C₂B₉H₁₂]⁻).

67. The composition of Embodiment 48-66, wherein the composition has an ionic conductivity of at least about 0.05 mS/cm.

68. The composition of Embodiment 48-66, wherein the composition has an ionic conductivity of at least about 0.1 mS/cm.

69. The composition of Embodiment 48-66, wherein the composition has an ionic conductivity of at least about 0.5 mS/cm.

70. The composition of Embodiment 48-66, wherein the composition has an ionic conductivity of at least about 1.0 mS/cm.

71. The composition of Embodiment 48-66, wherein the composition has an ionic conductivity of at least about 1.5 mS/cm.

72. The composition of Embodiment 48-66, wherein the composition has an ionic conductivity of at least about 2.0 mS/cm.

73. The composition of Embodiment 48-66, wherein the composition has an ionic conductivity of at least about 2.5 mS/cm.

74. The composition of Embodiment 48-66, wherein the composition has an ionic conductivity of at least about 2.7 mS/cm.

75. The composition of Embodiment 48-66, wherein the composition has an ionic conductivity of at least about 3.0 mS/cm.

76. The composition of Embodiment 48-66, wherein the composition has an ionic conductivity of at least about 3.5 mS/cm.

77. The composition of Embodiment 48-66, wherein the composition has an ionic conductivity of at least about 4.0 mS/cm.

78. The composition of Embodiment 48-66, wherein the composition has an ionic conductivity of at least about 4.3 mS/cm.

79. The composition of Embodiment 48-78, wherein the composition has an electronic conductivity of no more than about 10⁻⁶ S/cm.

80. The composition of Embodiment 48-78, wherein the composition has an electronic conductivity of no more than about 10⁻⁷ S/cm.

81. The composition of Embodiment 48-78, wherein the composition has an electronic conductivity of no more than about 10⁻⁸ S/cm.

82. The composition of Embodiment 48-78, wherein the composition has an electronic conductivity of no more than about 10⁻⁹ S/cm.

83. A composition comprising sodium cation, dicarbaundecaborate anion and an additional anion, wherein the composition has an ionic conductivity that is higher than that of sodium dicarbaundecaborate.

84. The composition of Embodiment 83, wherein the composition has an ionic conductivity of at least about 0.05 mS/cm.

85. The composition of Embodiment 83, wherein the composition has an ionic conductivity of at least about 0.1 mS/cm.

86. The composition of Embodiment 83, wherein the composition has an ionic conductivity of at least about 0.5 mS/cm.

87. The composition of Embodiment 83, wherein the composition has an ionic conductivity of at least about 1.0 mS/cm.

88. The composition of Embodiment 83, wherein the composition has an ionic conductivity of at least about 1.5 mS/cm.

89. The composition of Embodiment 83, wherein the composition has an ionic conductivity of at least about 2.0 mS/cm.

90. The composition of Embodiment 83, wherein the composition has an ionic conductivity of at least about 2.5 mS/cm.

91. The composition of Embodiment 83, wherein the composition has an ionic conductivity of at least about 2.7 mS/cm.

92. The composition of Embodiment 83, wherein the composition has an ionic conductivity of at least about 3.0 mS/cm.

93. The composition of Embodiment 83, wherein the composition has an ionic conductivity of at least about 3.5 mS/cm.

94. The composition of Embodiment 83, wherein the composition has an ionic conductivity of at least about 4.0 mS/cm.

95. The composition of Embodiment 83, wherein the composition has an ionic conductivity of at least about 4.3 mS/cm.

96. The composition of Embodiment 83-95, wherein the composition has an electronic conductivity of no more than about 10⁻⁶ S/cm.

97. The composition of Embodiment 83-95, wherein the composition has an electronic conductivity of no more than about 10⁻⁷ S/cm, preferably no more than about 10⁻⁸ S/cm, and more preferably no more than about 10⁻⁹ S/cm.

98. The composition of Embodiment 83-97, wherein the dicarbaundecaborate anion comprises 7,8-dicarbaundecaborate anion ([7,8-C₂B₉H₁₂]⁻).

99. The composition of Embodiment 83-97, wherein the dicarbaundecaborate anion is 7,8-dicarbaundecaborate anion ([7,8-C₂B₉H₁₂]⁻).

100. The composition of Embodiment 83-97, wherein the dicarbaundecaborate anion comprises 7,9-dicarbaundecaborate anion ([7,9-C₂B₉H₁₂]⁻).

101. The composition of Embodiment 83-97, wherein the dicarbaundecaborate anion is 7,9-dicarbaundecaborate anion ([7,9-C₂B₉H₁₂]⁻).

102. The composition of Embodiment 83-97, wherein the dicarbaundecaborate anion comprises a mixture of 7,8-dicarbaundecaborate anion ([7,8-C₂B₉H₁₂]⁻) and 7,9-dicarbaundecaborate anion ([7,9-C₂B₉H₁₂]⁻).

103 The composition of Embodiment 83-97, wherein the dicarbaundecaborate anion is a mixture of 7,8-dicarbaundecaborate anion ([7,8-C₂B₉H₁₂]⁻) and 7,9-dicarbaundecaborate anion ([7,9-C₂B₉H₁₂]⁻).

104. An electrolyte comprising the compound of embodiment 1-15 or the composition of embodiment 16-103.

105. The electrolyte of Embodiment 104, further comprising a negative electrode material.

106. The electrolyte of Embodiment 105, wherein the negative electrode material is a metal anode material, a metal elemental anode material, a nonmetal elemental anode material, an alloy material, or a transition metal oxide material.

107. The electrolyte of Embodiment 105-106, wherein the negative electrode material is a Na—Sn alloy.

108. The electrolyte of Embodiment 107, wherein the negative electrode material is a Na—Sn (2:1) alloy.

109. The electrolyte of Embodiment 104-108, further comprising a conductive material.

110. The electrolyte of Embodiment 109, wherein the conductive material is selected from the group consisting of graphite, carbon black, carbon fibers or metal fibers, metal powder, conductive whiskers, conductive metal oxide, activated carbon, polyphenylene derivatives, and combinations thereof.

111. The electrolyte of Embodiment 109, wherein the conductive material is selected from the group consisting of natural graphite, artificial graphite, Super-P, acetylene black, Ketjen black, channel black, furnace black, lamp black, thermal black, Denka black, vapor grown carbon fibers, and combinations thereof.

112. The electrolyte of Embodiment 104-111, further comprising a binder resin.

113. The electrolyte of Embodiment 112, wherein the binder resin is selected from the group consisting of polyvinylidene difluoride, polyvinylidene fluoride-co-hexafluoropropylene, polyvinylidene fluoride-co-trichloroethylene, polymethylmethacrylate, polyethylhexyl acrylate, polybutylacrylate, polyacrylonitrile, polyvinylpyrrolidone, polyvinylacetate, polyethylene-co-vinyl acetate, polyethylene oxide, polyarylate, cellulose acetate, cellulose acetate butyrate, cellulose acetate propionate, cyanoethylpullulan, cyanoethylpolyvinylalcohol, cyanoethylcellulose, cyanoethylsucrose, pullulan and carboxyl methyl cellulose, polyacrylic acid, polyacrylic acid salt derivatives, and combinations thereof.

114. A battery comprising: a) a negative electrode, b) a positive electrode and c) the electrolyte of Embodiment 104-113.

115. The battery of Embodiment 114, wherein the electrolyte is an anolyte.

116. The battery of Embodiment 114-115, wherein the positive electrode comprises sodium transition metal oxide active material as a positive electrode active material, and preferably the transition metal comprises at least one of Cr, Mn, Fe, Ni or V.

117. The battery of Embodiment 114-116, wherein the positive electrode comprises Na₃V₂(PO₄)₃ (NVP).

118. The battery of Embodiment 114-117, wherein the positive electrode comprises NaCrO₂ cathode (NCO).

119. The battery of Embodiment 114-118, wherein the negative electrode material is a metal anode material, a nonmetal elemental anode material, an alloy material, or a transition metal oxide material.

120 The battery of Embodiment 114-118, wherein the negative electrode material is a Na—Sn alloy.

121. The battery of Embodiment 114-118, wherein the negative electrode material is a Na—Sn (2:1) alloy.

122 The battery of Embodiment 114-121, wherein the negative electrode and/or the positive electrode further comprising a conductive material.

123. The battery of Embodiment 122, wherein the conductive material is selected from the group consisting of graphite, carbon black, carbon fibers or metal fibers, metal powder, conductive whiskers, conductive metal oxide, activated carbon, polyphenylene derivatives, and combinations thereof.

124 The battery of Embodiment 123, wherein the conductive material is selected from the group consisting of natural graphite, artificial graphite, super-p, acetylene black, ketjen black, channel black, furnace black, lamp black, thermal black, denka black, vapor grown carbon fibre, and combinations thereof.

125 The battery of Embodiment 114-124, the negative electrode and/or the positive electrode further comprises a binder resin.

126. The battery of Embodiment 125, wherein the binder resin is selected from the group consisting of polyvinylidene difluoride, polyvinylidene fluoride-co-hexafluoropropylene, polyvinylidene fluoride-co-trichloroethylene, polymethylmethacrylate, polyethylhexyl acrylate, polybutylacrylate, polyacrylonitrile, polyvinylpyrrolidone, polyvinylacetate, polyethylene-co-vinyl acetate, polyethylene oxide, polyarylate, cellulose acetate, cellulose acetate butyrate, cellulose acetate propionate, cyanoethylpullulan, cyanoethylpolyvinylalcohol, cyanoethylcellulose, cyanoethylsucrose, pullulan and carboxyl methyl cellulose, polyacrylic acid, polyacrylic acid salt derivatives, and combinations thereof.

127. The battery of Embodiment 114-126, further comprising a catholyte.

128. The battery of Embodiment 127, wherein the catholyte comprises a reference closo-borate.

129. The battery of Embodiment 127, wherein the catholyte comprises a reference halide.

130. The battery of Embodiment 114-129, wherein the battery exhibits no Na plating at 3C.

131. The battery of Embodiment 114-130, wherein the battery exhibits no Na plating at 4C.

132. The battery of Embodiment 114-131, wherein the battery exhibits no Na plating at 5C.

133. The battery of Embodiment 114-132, wherein the battery has a Coulombic efficiency of at least 60%, preferably at least 90%, and more preferably at least 95% for the first 20 cycles.

134 The battery of Embodiment 114-133, wherein the battery has a Coulombic efficiency of at least 60%, preferably at least 90%, and more preferably at least 95% for the first 15 cycles.

135. The battery of Embodiment 114-133, wherein the battery has a Coulombic efficiency of at least 60%, preferably at least 90%, and more preferably at least 95% for the first 10 cycles.

136. The battery of Embodiment 114-133, wherein the battery has a Coulombic efficiency of at least 60%, preferably at least 90%, and more preferably at least 95% for the first 5 cycles.

137. The battery of Embodiment 114-133, wherein the battery has a Coulombic efficiency of at least 60%, preferably at least 90%, and more preferably at least 95% for the first 2 cycles.

138. The battery of Embodiment 114-133, wherein the battery has a Coulombic efficiency of at least 60%, preferably at least 90%, and more preferably at least 95% for the first cycle.

139. The batter of Embodiment 114-138, wherein the battery has a negative electrode capacity to positive electrode capacity (N/P) ratio of 0.1 to 30.0.

### NON-LIMITING EXAMPLES

The following Examples are detailed by way of illustration only and are not to be construed as limiting in spirit or in scope, many modifications both in materials and in methods will be apparent to those skilled in the art.

### Example 1—Manufacturing—Ball-Milling Process

In some embodiments, the chemical reaction between sodium diuncarbadecaborate (Na[7,8-C₂B₉H₁₂] or Na[7,9-C₂B₉H₁₂]⁻) and Na₂B₁₂H₁₂, i.e. the precursor materials, to make the solid electrolyte, takes place via a one-step chemo-mechanical reaction. Due to the air- and moisture-sensitivity of the precursor materials, all material handling is done within an inert environment unless otherwise noted.

The two materials are mixed in a predetermined molar ratio in a mortar and pestle, then placed into a ball milling vessel with grinding media and sealed. The mixture is ball-milled (e.g. over 2 hours at 500 rpm) and then the materials are extracted within the glovebox.

### Example 2—Manufacturing—Solvent Process

In some embodiments, the chemical reaction between sodium diuncarbadecaborate (Na[7,8-C₂B₉H₁₂] or Na[7,9-C₂B₉H₁₂]⁻) and Na₂B₁₂H₁₂, i.e. the precursor materials, to make the solid electrolyte, takes place via a one-step solvent-mediated reaction.

As a non-limiting example, (Na[7,8-C₂B₉H₁₂] or Na[7,9-C₂B₉H₁₂]⁻) and Na₂B₁₂H₁₂ are dissolved in a solvent, e.g. ethanol, methanol, or isopropanol. The solvent is removed by heating the mixture at an elevated temperature (e.g. 100-250° C.), upon which the solid electrolyte precipitates out.

### Example 3—Crystallinity/Amorphousness

To demonstrate the crystallinity/amorphousness of the disclosed electrolyte compound and composition, various precursor compounds and electrolyte compounds were analyzed using XRD. FIG. 1 shows a X-ray diffraction pattern of the electrolyte Na₂₋ₓ([7,8-C₂B₉H₁₂]⁻)ₓ(B₁₂H₁₂)₁₋ₓ, where x=0.33, 0.5, 0.66, and 0.75, which corresponds to C278_{y}, where y=0.5, 1, 2, and 3, additionally with references for the precursors Na([7,8-C₂B₉H₁₂]⁻) and Na₂B₁₂H₁₂. This shows that processing of the mixture of Na([7,8-C₂B₉H₁₂]⁻):(Na₂B₁₂H₁₂) yields a new compound.

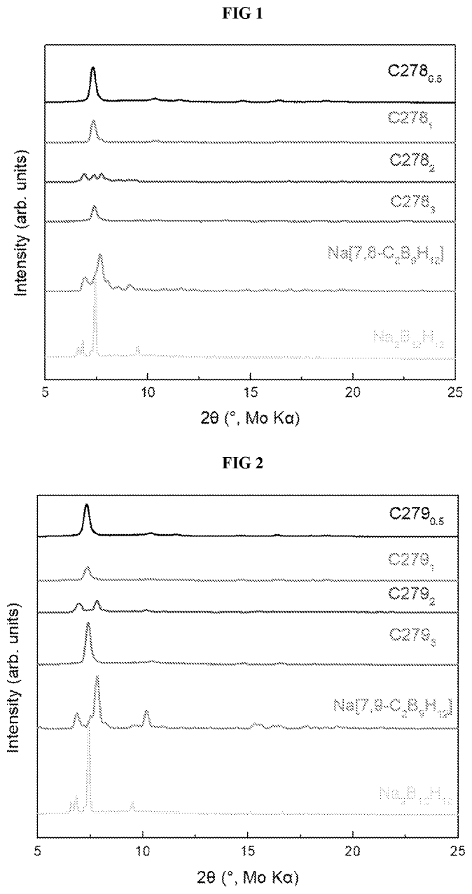

FIG. 2 shows a X-ray diffraction pattern of the electrolyte Na₂₋ₓ([7,9-C₂B₉H₁₂]⁻)ₓ(B₁₂H₁₂)₁₋ₓ, where x=0.33, 0.5, 0.66, and 0.75, which corresponds to C279_{y}, where y=0.5, 1, 2, and 3, additionally with references for the precursors Na([7,9-C₂B₉H₁₂]⁻) and Na₂B₁₂H₁₂. This shows that processing of the mixture of Na([7,9-C₂B₉H₁₂]⁻):(Na₂B₁₂H₁₂) yields a new compound.

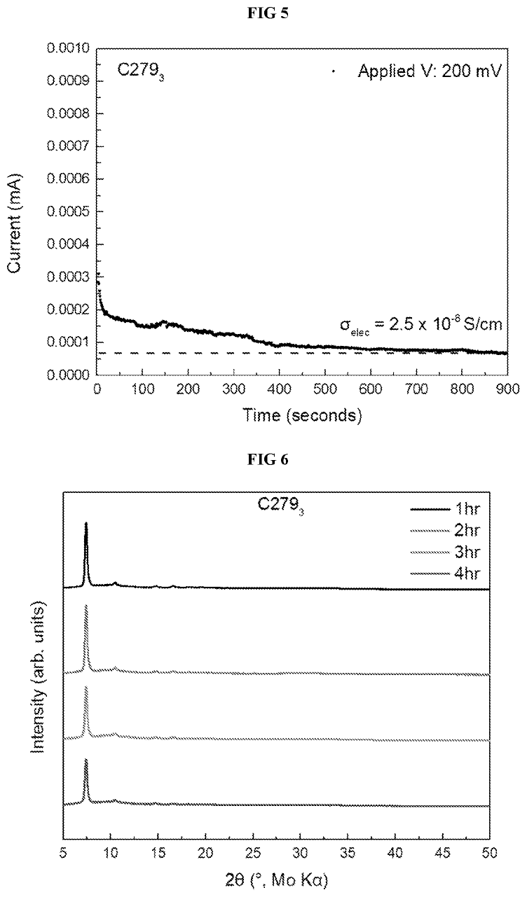

FIG. 6 shows the X-ray diffraction pattern of the electrolyte C279₃ taken after every 1 hour of processing. Evident is that the target sodium-ion conductor is synthesized after just 1 hour of processing; no changes to the structure are observed after further processing.

### Example 4—Ionic Conductivity

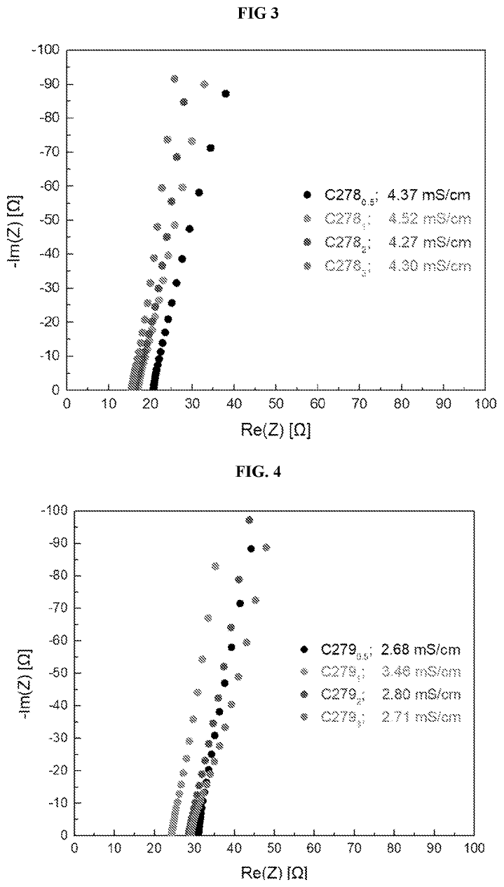

To demonstrate the ionic conductivity of the disclosed electrolyte compound and composition, multiple example electrolyte compounds/compositions were evaluated. FIG. 3 shows the ionic conductivity of the electrolyte C278_{y}, where y=0.5, 1, 2, and 3, All the molar ratios show a high conductivity, values suitable for use in sodium secondary batteries.

FIG. 4 shows the ionic conductivity of the electrolyte C279_{y}, where y=0.5, 1, 2, and 3, All the molar ratios show a high conductivity, values suitable for use in sodium secondary batteries.

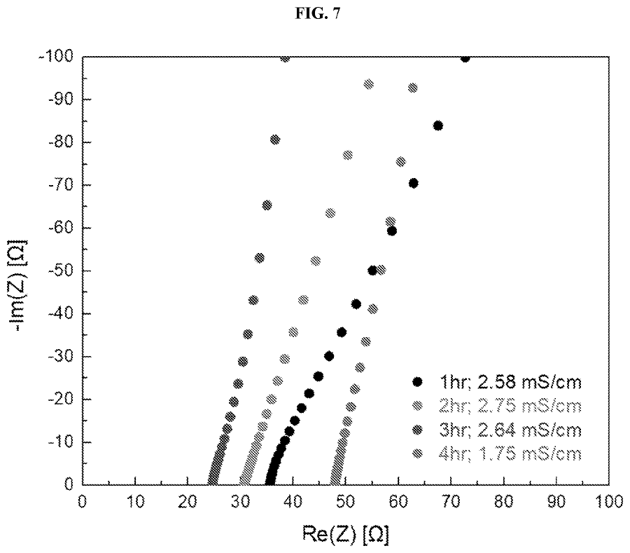

FIG. 7 shows the ionic conductivity of the electrolyte C279₃, taken after every 1 hour of processing. Along with FIG. 6, it is evident that the target sodium-ion conductor is synthesized after just 1 hour of processing; no changes with regards to its structure nor significant changes in its ionic conductivity are observed.

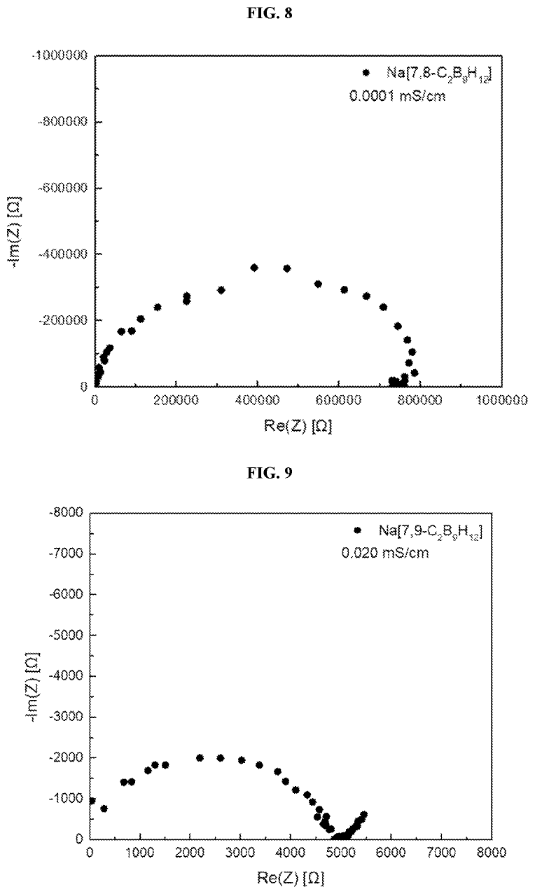

FIG. 8 shows the ionic conductivity of the electrolyte precursor Na([7,8-C₂B₉H₁₂]⁻). The ionic conductivity value is 0.0001 mS/cm, orders of magnitude lower than the electrolyte C278_{y}. Thus, a mixture of Na([7,8-C₂B₉H₁₂]⁻) and Na₂B₁₂H₁₂ clearly produces a compound with superior properties than their precursors.

FIG. 9 shows the ionic conductivity of the electrolyte precursor Na([7,9-C₂B₉H₁₂]⁻). The ionic conductivity value is 0.020 mS/cm, orders of magnitude lower than the electrolyte C279_{y}. Thus, a mixture of Na([7,9-C₂B₉H₁₂]⁻) and Na₂B₁₂H₁₂ clearly produces a compound with superior properties than their precursors.

### Example 5—Electronic Conductivity

To demonstrate the electronic conductivity of the disclosed electrolyte compound and composition, an example electrolyte compound/composition was evaluated. FIG. 5 shows the electronic conductivity of the electrolyte C279₃. The low electronic conductivity indicates that this material is primarily an ionic conductor, and thus a sodium ion conductor, suitable for use in secondary batteries.

### Example 6—Rate Performance

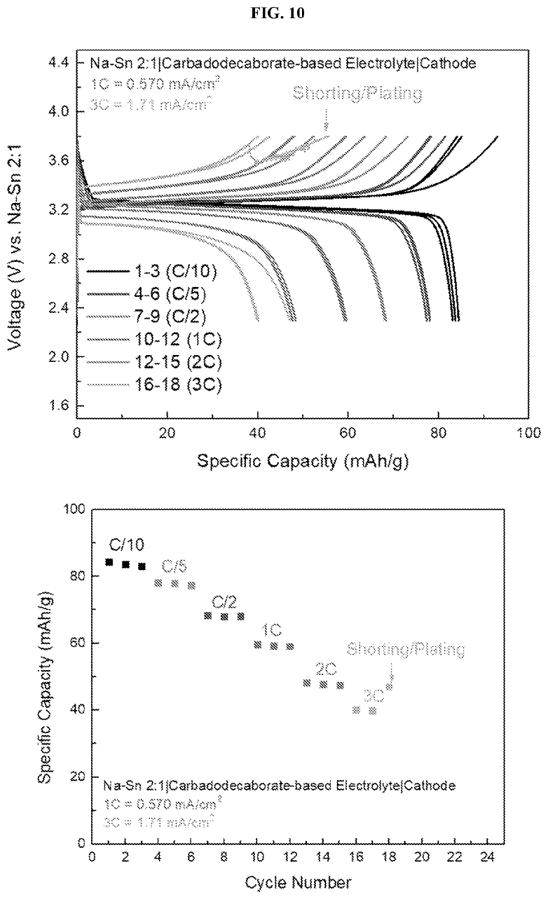

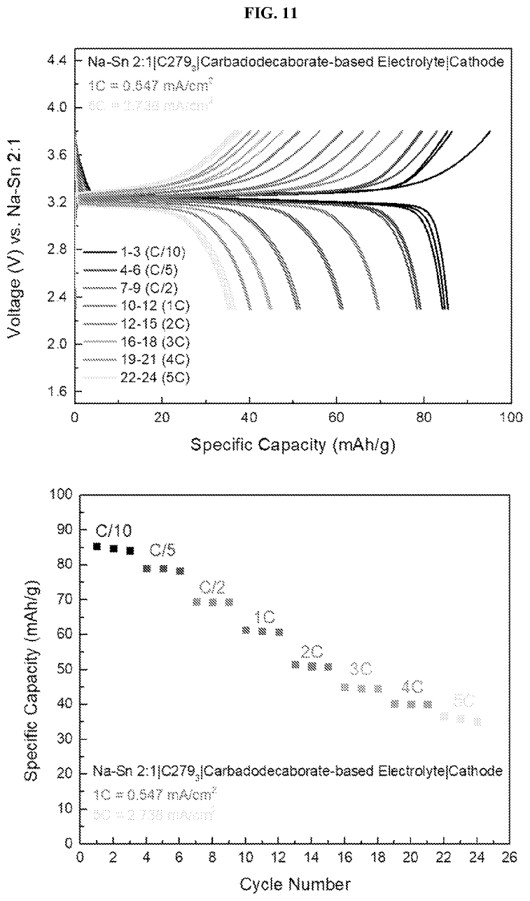

To demonstrate the rate performance of the disclosed battery, an example battery using the disclosed compound/composition was evaluated against a reference battery using a known. electrolyte compound/composition. FIG. 10 shows the rate performance of the sodium secondary battery, comprising of Na—Sn 2:1 as the anode, a reference carbadodecaborate electrolyte, and a Na₃V₂(PO₄)₃ cathode (NVP). Na plating, or soft shorting, is observed on the third cycle at a rate of 3C.

FIG. 11 shows the rate performance of the sodium secondary battery, comprising of Na—Sn 2:1 as the anode, C279₃ as the anolyte, a reference borate as the catholyte, and a Na₃V₂(PO₄)₃ cathode (NVP). Soft shorting was not observed at a rate of 3C, 4C, or 5C, showing that the addition of C279₃ increased the rate performance of the sodium secondary battery.

### Example 7—Symmetric Cell Data

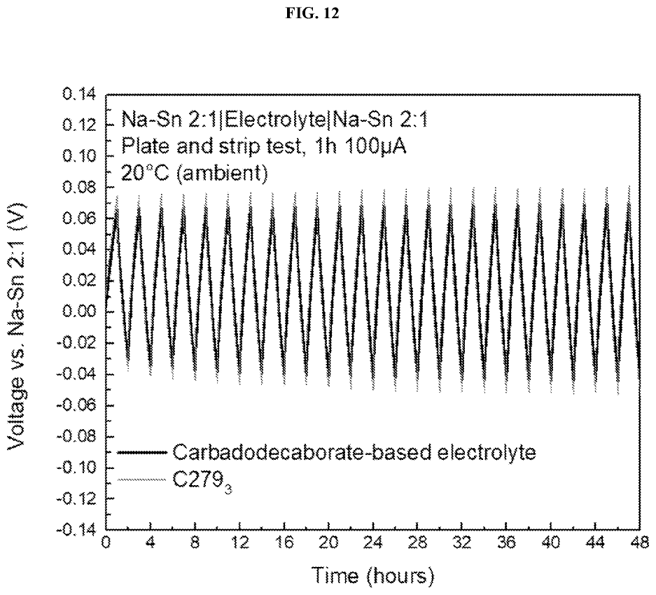

FIG. 12 shows symmetric cell data, where the electrolyte C279₃ is sandwiched between Na—Sn 2:1 electrodes. For comparison, the same test using a reference borate is included. Both configurations had 100 μA applied over 1 hr (charge) then a subsequent discharge of 100 μA applied over 1 hr, for a total duration of 48 hrs. Both borates show similar behavior, in that impedance does not grow over time (which would have been indicated by a corresponding increase in the amplitude of the voltage response). This means that both compounds are suitable as anolytes and stable at the anode side.

### Example 8—Cycling Performance

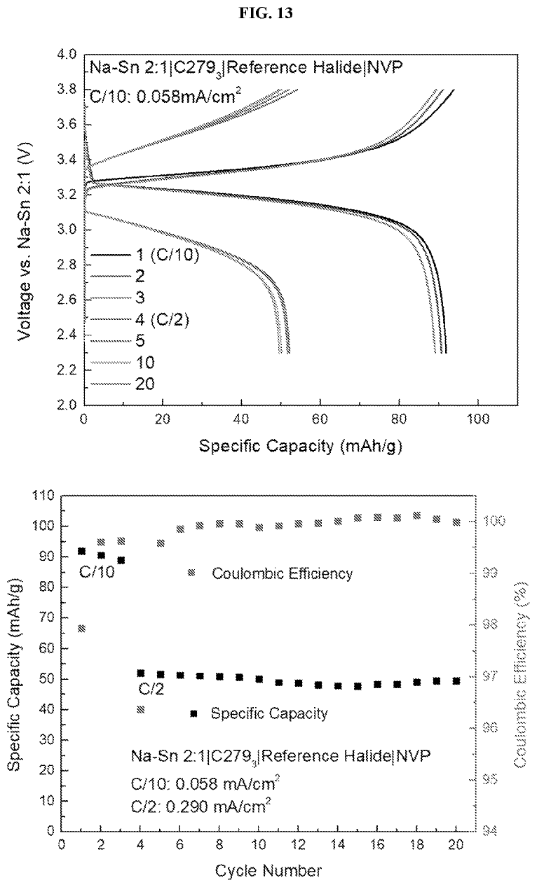

To demonstrate the cycling performance of the disclosed battery, various example batteries were evaluated. FIG. 13 shows the cycling performance of a sodium secondary battery, comprising of Na—Sn 2:1 as the anode, C279₃ as the anolyte, a reference halide as the catholyte, and a Na₃V₂(PO₄)₃ cathode (NVP). The first 20 cycles are shown (both the voltage vs. specific capacity, and specific capacity vs. cycle number). This shows that C279₃ is suitable as an anolyte and can be used with different catholytes in a sodium secondary battery.

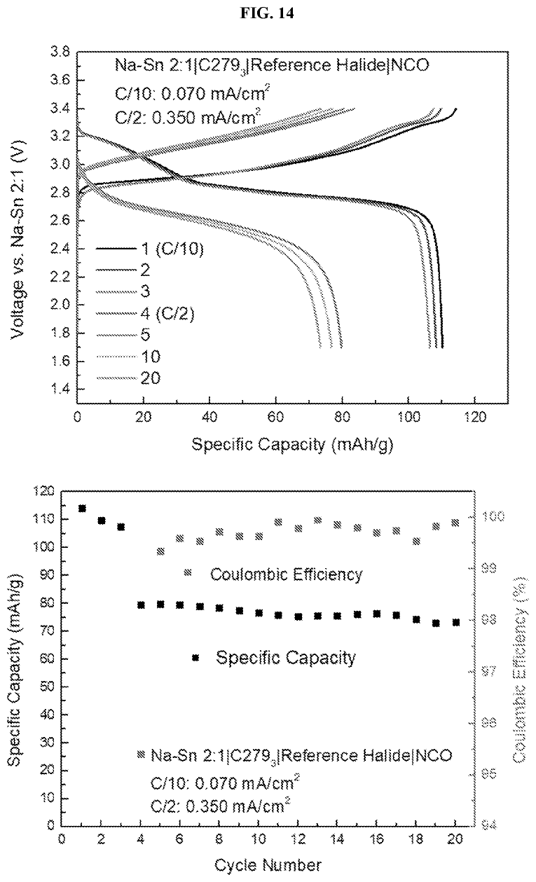

FIG. 14 shows the cycling performance of a sodium secondary battery, comprising of Na—Sn 2:1 as the anode, C279₃ as the anolyte, a reference halide as the catholyte, and a NaCrO₂ cathode (NCO). The first 20 cycles are shown (both the voltage vs. specific capacity, and specific capacity vs. cycle number). Along with FIG. 13, this shows that C279₃ is suitable as an anolyte, and can be used with not only different catholytes but different cathodes in a sodium secondary battery.

### Example 9—First Cycle Coulombic Efficiency

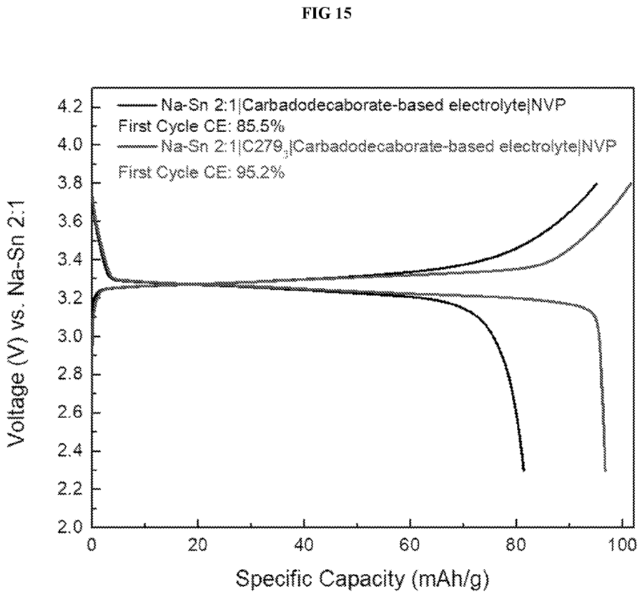

To demonstrate the first cycle Coulombic efficiency of the disclosed battery, various example batteries were evaluated. FIG. 15 shows a comparison of the first cycle of a sodium secondary battery, comprising of Na—Sn 2:1 as the anode, C279₃ as the anolyte, a reference borate as the catholyte, and a NVP as the cathode, and another battery comprising of Na—Sn 2:1 as the anode, a reference borate as the electrolyte, and a NVP as the cathode. A higher first cycle Coulombic efficiency is observed (95.2% to 85.5%), which shows show that C279₃ is a suitable as an anolyte and its inclusion improves the overall stability of the secondary battery.

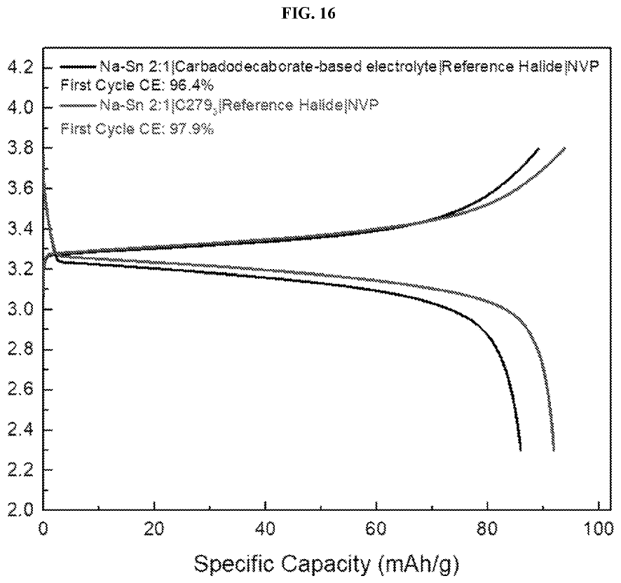

FIG. 16 shows another comparison of the first cycle of a sodium secondary battery, comprising of Na—Sn 2:1 as the anode, C279₃ as the anolyte, a reference halide as the catholyte, and a NVP as the cathode, and another battery comprising of Na—Sn 2:1 as the anode, a reference halide as the electrolyte, and a NVP as the cathode. A higher first cycle Coulombic efficiency is observed (97.9% to 96.4%), which shows show that C279₃ is suitable as an anolyte and its inclusion improves the overall stability of the secondary battery.

1. A solid electrolyte composition comprising sodium cation (Na⁺), dicarbaundecaborate anion ([C₂B₉H₁₂]⁻), and dodecahydrododecaborate anion ([B₁₂H₁₂]²).

2. The solid electrolyte composition of claim 1, wherein the composition consists essentially of sodium cation (Na⁺), dicarbaundecaborate anion ([C₂B₉H₁₂]⁻), and dodecahydrododecaborate anion ([B₁₂H₁₂]²⁻).

3. The solid electrolyte composition of claim 1, wherein the molar ratio between dicarbaundecaborate anion and dodecahydrododecaborate anion is from 0.01 to 10.0.

4. The solid electrolyte composition of claim 1, wherein the molar ratio between dicarbaundecaborate anion and dodecahydrododecaborate anion is from 0.01 to 0.7, from 0.7 to 1.5, from 1.5 to 2.5, or from 2.5 to 10.

5. (canceled)

6. (canceled)

7. The solid electrolyte composition of claim 1, wherein the dicarbaundecaborate anion comprises 7,8-dicarbaundecaborate anion ([7,8-C₂B₉H₁₂]⁻), 7,9-dicarbaundecaborate anion ([7,9-C₂B₉H₁₂]−), or a mixture of 7,8-dicarbaundecaborate anion ([7,8-C₂B₉H₁₂]−) and 7,9-dicarbaundecaborate anion ([7,9-C₂B₉H₁₂]−).

8. (canceled)

9. (canceled)

10. (canceled)

11. The solid electrolyte composition of claim 1, wherein the composition has an ionic conductivity of at least about 2.0 mS/cm.

12. The solid electrolyte composition of claim 1, wherein the composition has an ionic conductivity of at least about 2.5 mS/cm.

13. The solid electrolyte composition of claim 1, wherein the composition has an ionic conductivity of at least about 3.0 mS/cm.

14. The solid electrolyte composition of claim 1, wherein the composition has an ionic conductivity of at least about 4.0 mS/cm.

15. The solid electrolyte composition of claim 1, wherein the composition has an ionic conductivity of at least about 4.3 mS/cm.

16. The solid electrolyte composition of claim 1, wherein the composition has an electronic conductivity of no more than about 10⁻⁷ S/cm.

17. The solid electrolyte composition of claim 1, wherein the composition has an electronic conductivity of no more than about 10⁻⁸ S/cm.

18. The solid electrolyte composition of claim 1, wherein the composition has an electronic conductivity of no more than about 10⁻⁹ S/cm.

19. (canceled)

20. (canceled)

21. An electrolyte comprising the solid electrolyte composition of claim 1.

22. The electrolyte of claim 21, further comprising a negative electrode material comprising a metal anode material, a metal elemental anode material, a nonmetal elemental anode material, an alloy material, or a transition metal oxide material.

23. (canceled)

24. The electrolyte of claim 22, wherein the negative electrode material is a Na—Sn alloy.

25. The electrolyte of claim 21, further comprising a conductive material selected from the group consisting of graphite, carbon black, carbon fibers or metal fibers, metal powder, conductive whiskers, conductive metal oxide, activated carbon, polyphenylene derivatives, and combinations thereof.

26. (canceled)

27. The electrolyte of claim 21, further comprising a binder resin selected from the group consisting of polyvinylidene difluoride, polyvinylidene fluoride-co-hexafluoropropylene, polyvinylidene fluoride-co-trichloroethylene, polymethylmethacrylate, polyethylhexyl acrylate, polybutylacrylate, polyacrylonitrile, polyvinylpyrrolidone, polyvinylacetate, polyethylene-co-vinyl acetate, polyethylene oxide, polyarylate, cellulose acetate, cellulose acetate butyrate, cellulose acetate propionate, cyanoethylpullulan, cyanoethylpolyvinylalcohol, cyanoethylcellulose, cyanoethylsucrose, pullulan and carboxyl methyl cellulose, polyacrylic acid, polyacrylic acid salt derivatives, and combinations thereof.

28. (canceled)

29. A sodium battery comprising: a) a negative electrode, b) a positive electrode and c) the electrolyte of claim 21.

30. The battery of claim 29, wherein the electrolyte is an anolyte.
